(19) United States
(12) Patent Application Publication
(10) Pub. No.: US 2016/0076287 A1
(43) Pub. Date: Mar. 17, 2016

(54) Door Hinge Cover

(71) Applicant: Guido Sandoval, North Charleston, SC (US)

(72) Inventor: Guido Sandoval, North Charleston, SC (US)

(21) Appl. No.: 14/837,137

(22) Filed: Aug. 27, 2015

Related U.S. Application Data
(60) Provisional application No. 62/051,339, filed on Sep. 17, 2014.

(51) Int. Cl. E05D 11/00; B05B 15/04

(52) U.S. Cl. CPC E05D 11/0054; B05B 15/0456

(57) ABSTRACT

A hinge cover for a door hinge that can be used to temporarily protect the door hinge from paint while the door and nearby surfaces are being painted. The hinge cover includes a front cover and a rear cover, wherein the front cover can be secured to the interior portion of a hinge, and wherein the rear cover can be secured to the exterior portion of a hinge so that the hinge is fully enclosed. The front cover includes a body having a pair of sides for covering the door plate and frame plate of a hinge, and further includes tabs on the upper and lower ends thereof that can be secured around the knuckle of the hinge. The rear cover comprises a rectangular body. The outer and front covers preferably include adhesive surfaces for removably affixing the outer and front covers to a door hinge.

### CROSS REFERENCE TO RELATED APPLICATION

This application claims the benefit of U.S. Provisional Application No. 62/051,339 filed on Sep. 17, 2014. The above identified patent application is herein incorporated by reference in its entirety to provide continuity of disclosure.

### BACKGROUND OF THE INVENTION

### Field of the Invention

The present invention relates to hinge covers. More specifically, the present invention provides a hinge cover that can be applied to a door hinge to protect the hinge from paint while a user is painting the door and door frame and that can be subsequently removed therefrom. The hinge cover comprises a front cover and a rear cover, wherein the covers are applied to the front side and rear side of a hinge so that the hinge is fully covered.

It can be difficult to protect a door hinge while painting a door, doorframe, and surrounding surfaces. Stray paint marks on a hinge can negatively affect the appearance of the hinge and can make the painter's work appear sloppy. Thus, the painter must carefully paint the area around a hinge so as to prevent paint from staining the hinge. However, painting the areas around hinges can be time consuming and difficult as a result of the care that must to be taken to avoid painting the hinge. While some people may choose to remove the door hinge from the door until the door has been painted, this is time consuming and inconvenient. Thus, a protective cover that can be applied to a door hinge while a door attached thereto is being painted is desired to allow a painter to more easily paint a door without getting paint on the hinge.

Devices have been disclosed in the prior art that relate to hinge covers. These include devices that have been patented and published in patent application publications. These devices generally relate to adhesive hinge covers for protecting a hinge while painting, such as U.S. Patent Application Publication Number 2001/0036540, U.S. Pat. No. 5,722,120, U.S. Pat. No. 7,922,844, U.S. Patent Application Publication Number 2008/0244867, and U.S. Pat. No. 6,854,162.

These prior art devices have several known drawbacks. The hinge covers in the prior art fail to provide a cover for both the front side and rear side of the hinge, and provide a cover for only the front side thereof. Accordingly, the hinge covers in the prior art are only useful for painting the front side of the hinge that is exposed when a door is opened, but fail to provide protection for the rear side of a hinge that is visible when a door is closed. Thus, the present invention provides a hinge cover having a front cover and a rear cover, wherein the covers are sized and shaped so as to fully cover the interior and exterior portions of a hinge.

In light of the devices disclosed in the prior art, it is submitted that the present invention substantially diverges in design elements from the prior art and consequently it is clear that there is a need in the art for an improvement to existing hinge cover devices. In this regard the instant invention substantially fulfills these needs.

### SUMMARY OF THE INVENTION

In view of the foregoing disadvantages inherent in the known types of hinge covers now present in the prior art, the present invention provides a new hinge cover wherein the same can be utilized for providing convenience for the user when painting the area around a door hinge.

It is therefore an object of the present invention to provide a new and improved hinge cover comprising a front cover and a rear cover adapted to be removably affixed to the front side and rear side of a hinge so as to fully cover the hinge during painting.

It is another object of the present invention to provide a hinge cover comprising a front cover having a body with a square shape so as to cover the door plate and frame plate of the hinge in addition to the central portion or knuckle of the hinge, wherein the body further includes an upper tab and a lower tab adapted to be wrapped around the knuckle so as to cover the upper and lower portions thereof.

Another object of the present invention is to provide a hinge cover having a rear cover with a rectangular configuration, wherein the rear cover is adapted to be placed on the rear side of the hinge so as to cover the exposed portions of the frame plate, door plate, and the central knuckle.

Yet another object of the present invention is to provide a hinge cover sized and shaped so as to fully cover a door hinge.

An additional object of the present invention is to provide a hinge cover having an adhesive thereon for removably affixing the hinge cover to a door hinge.

Another object of the present invention is to provide a hinge cover that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows front views of the front cover and rear cover of the hinge cover.

FIG. 2 shows a perspective view of the front cover as positioned for application to the front side of a hinge.

FIG. 3 shows a perspective view of the rear cover as positioned for application to the rear side of a hinge.

### DETAILED DESCRIPTION OF THE INVENTION

Reference is made herein to the attached drawings. Like reference numerals are used throughout the drawings to depict like or similar elements of the hinge cover. For the purposes of presenting a brief and clear description of the present invention, the preferred embodiment will be discussed as used for covering a hinge on a door. The figures are intended for representative purposes only and should not be considered to be limiting in any respect.

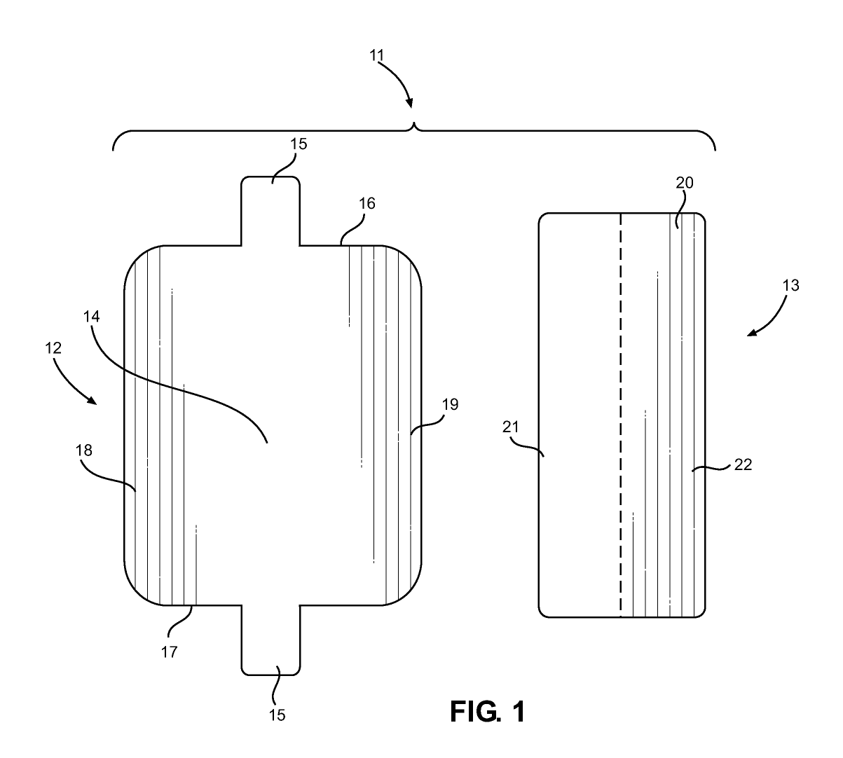

Referring now to FIG. 1, there are shown front views of the front cover and rear cover of the hinge cover. The hinge cover 11 of the present invention comprises a front cover 12 and a rear cover 13 adapted to be removably secured to the front side and rear side of a hinge, respectively. The hinge cover 11 is composed of a thin sheet of flexible material that can shape to the surface on which it is applied. Preferably, the hinge cover 11 is waterproof so that liquid or paint cannot pass through the cover and contact the hinge thereunder. Further, the hinge cover 11 includes an adhesive on an underside surface thereof, wherein the hinge cover 11 is removably affixable to a door hinge via the adhesive thereon so that the hinge cover 11 can be applied prior to painting and can be removed thereafter.

The front cover 12 comprises a body 14 that is sized and shaped so as to fully cover a door hinge. The body 14 comprises a substantially rectangular shape in the illustrated embodiment, wherein the body includes a first side 18 and a second side 19. The first side 18 is adapted to be affixed to the door panel of a door hinge and the second side 19 is adapted to be affixed to the frame panel of a door hinge. The front cover 12 further includes an upper end 16 and a lower end 17, wherein each of the upper end and lower ends includes a tab 15 thereon. The tab 15 is centrally positioned on the body 14 so that it aligns with the central knuckle of the hinge. The tabs 15 are adapted to be folded around the hinge so as to protect the upper and lower surfaces of the knuckle of the hinge.

The rear cover 13 comprises a body 20 having a rectangular shape. The rear cover 13 is adapted to be positioned on the rear side of a door hinge, wherein the rear side is the portion that is visible when the door is closed. The body includes a first side 21 and a second side 22, wherein the first side 21 is adapted to be secured to a frame panel of a door hinge and the second side 22 is adapted to be secured to the door panel of a door hinge.

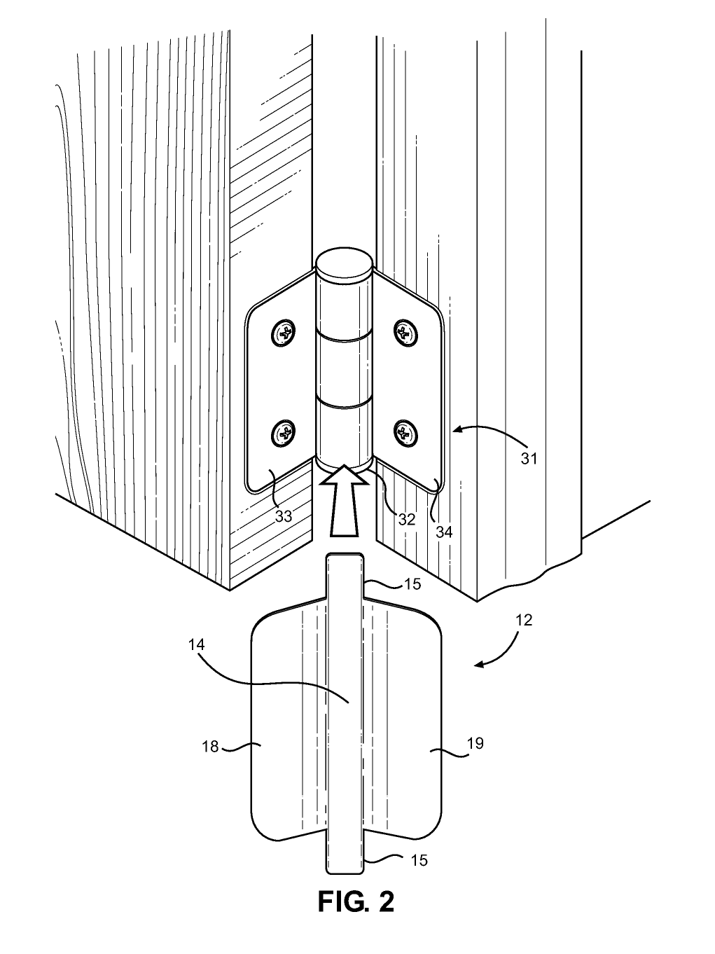

Referring now to FIG. 2, there is shown a perspective view of the front cover as positioned for application to the front side of a hinge. In operation, a door can be positioned in an open configuration, so that the front side of the hinge 31 is visible. The hinge 31 includes a door plate 33 affixed to the door, a central portion or knuckle 32, and a frame plate 34 affixed to the doorframe. The front cover 12 is sized so as to fully cover the front side of the hinge 31 and can be aligned therewith such that the adhesive is facing the door hinge 31. The first side 18 of the body 14 is positioned on the door plate 33 of the door hinge 32, and the second side 19 of the body 14 positioned on the frame plate 34 of the door hinge 31. The tabs 15 on the upper and lower ends of the body 14 can be folded around the knuckle 32 of the door hinge 31 so as to cover the upper and lower ends thereof.

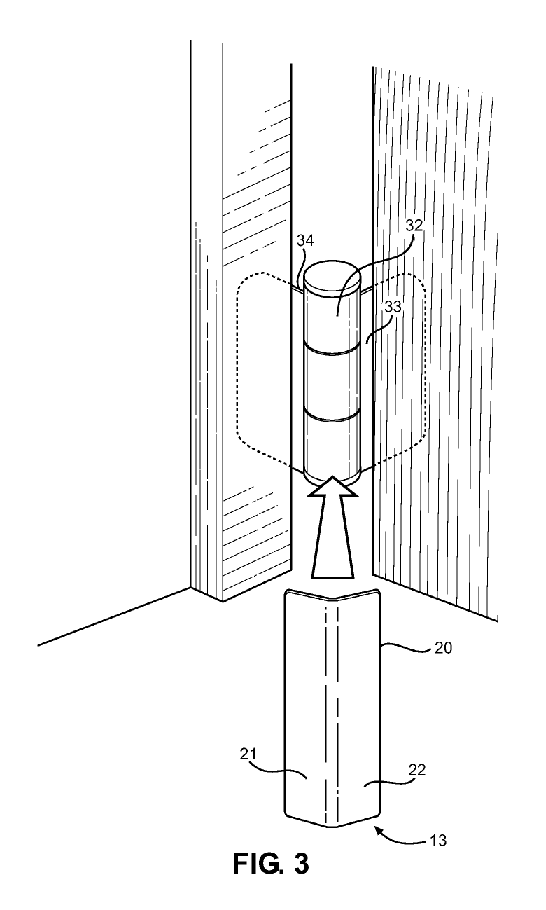

Referring now to FIG. 3, there is shown a perspective view of the rear cover as positioned for application to the exterior surface of a hinge. The rear cover 13 is adapted to be secured to the rear side of a door hinge. The exterior portion is accessible when the door is closed. The rear cover 13 comprises a rectangular body 20 having a first side 21 and a second side 22. The first side 21 is adapted to be positioned over and removably secured to the frame plate 34 of the door hinge and the second side 22 of the body 20 is adapted to be removably secured to the door plate 33 of the door hinge via the adhesive thereon. Thus, the rear cover 13 fully covers the rear side of the door hinge.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hinge cover, comprising:
a front cover having a substantially rectangular body adapted to be positioned over a front side of a door hinge;
wherein said body of said front cover comprises an upper end having a tab thereon and a lower end having a tab thereon, wherein said tabs are positioned centrally on said body;
a rear cover having a substantially rectangular shaped body adapted to be positioned over a rear side of said door hinge.

2) The hinge cover of claim 1, wherein said rear cover comprises an adhesive on a surface thereof for affixing said rear cover to said door hinge.

3) The hinge cover of claim 1, wherein said front cover comprises an adhesive on a surface thereof for affixing said rear cover to said door hinge.

4) The hinge cover of claim 1, wherein said front cover and said rear cover are composed of a flexible material.
